(19) United States
(12) Patent Application Publication
(10) Pub. No.: US 2005/0083860 A1
(43) Pub. Date: Apr. 21, 2005

(54) Determining distance to echo points on a wire-line medium

(75) Inventors: Ravishankar Sankaranarayanan, Bangalore (IN); Satya Sudhakar Yedlapalli, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/684,363

(22) Filed: Oct. 15, 2003

(51) Int. Cl. H04B 3/20

(52) U.S. Cl. 370/286

(57) ABSTRACT

Determining distance to echo points on a wire-line medium from a testing point. A sequence of test bits may be transmitted from one end (testing point) of a wire-line medium. An echo is deemed to be received if a monitored bit stream equals/matches the transmitted sequence. The distance to the echo point is computed by multiplying half the time to receive the echo with a velocity of propagation of the bits. In an embodiment, the transmitted sequence is chosen to exhibit good auto-correlation property, which enables the reception of the echo to be determined reliably.

### BACKGROUND OF THE INVENTION

1. Field of the Invention

The present invention relates to single-ended testing of a wire-line medium (e.g., local loop used in digital subscriber loop (DSL)), and more specifically to a method and apparatus for determining distance to echo points on a wire-line medium.

2. Related Art

Wire-line medium is often provided between devices to enable data transfer. For example, local loops (usually in the form of copper twisted pairs) are provided between digital subscriber loop access multiplexor (DSLAM) and a customer premise equipment (CPE)). The transferred data generally enables various user applications to be implemented on end systems (e.g., personal computers at one end and server systems on the other) as is well known in the relevant arts.

Wire-line medium often contains several echo points. Echo points correspond to points/portion in a wire-line medium which reflect a part of any incident (on the echo points) signal resulting in an echo. In general, incident signal is reflected by specific points at which the characteristic impedance of the wire-line medium changes. For example, characteristic impedance of the wire-line may change at points at which gauge changes, bridge taps are present and where the medium (e.g., local loop) ends.

There is often a need to determine the distance to echo points. For example, in the case of DSL based networks, a service provider may wish to determine the distance to each echo point of a local loop, which in turn enables the various characteristics (e.g., specific points at which gauge changes, where taps are presents, etc.) of the wire-line medium to be determined. Such characteristics generally enable service providers to determine whether the local loop is suitable for providing desired quality of services (e.g., high bandwidth), and is often referred to as ‘qualifying the loop’.

In one prior approach based on time domain reflectometry (TDR), a pulse is transmitted from one end of the wire-line medium. A single determination of distance to each of the echo points may be performed based on the amount of time taken for the respective echoes to be received back. For reliability, several of such single determinations may be performed by sending a corresponding number of pulses.

One problem with the above prior approach is that the approach may not scale well to long distances (e.g., more than a few kilo feet) and/or to a desired resolution (i.e., minimum distance between two echo points, which can be accurately determined). In general, using the above-described approach for long distances requires increasing the amplitude and/or width of the pulse. The nature of the medium or the maximum transmit power generally permitted by standards, may not permit increase of the amplitude beyond a specific limit.

Similarly, increasing the pulse width generally increases the probability of echoes overlapping when the echo points are close. In other words, the desired resolution may limit the pulse width. Thus, the above-described approaches may not scale well to testing long local loops and/or to provide a desired high resolution.

At least for such reasons, an improved approach may be desirable to determine distance to echo points on a wire-line medium.

### SUMMARY OF THE INVENTION

An aspect of the present invention enables determination of distance to an echo point in a wire-line medium. To perform a single determination of the distance, a first pre-determined sequence of bits are transmitted on the wire-line medium. The medium is monitored to determine the reception of the first sequence of bits as an echo from the echo point. The distance to the echo point is computed according to the time taken to receive the echo. The determinations can be repeated several times to reliably determine the distance.

According to another aspect of the present invention, the first sequence of bits (transmitted on the medium) is chosen to exhibit good auto-correlation property. A bit sequence (sequence of bits) is said to have good auto-correlation property if the sequence of bits exhibits a low correlation with the bit sequence shifted by one or more positions. As a result, the reception of echos can be determined reliably.

As the approaches merely require the ability to distinguish a bit on a echoed signal as either being a 0 or a 1, the approaches may scale well to long distances and high resolution. The approaches above can be used to determine distances to echo points in wire-line medium such as local loops used in association with DSL based networks.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the following accompanying drawings.

FIG. 1A is an example environment in which the present invention can be implemented.

FIG. 1B is a block diagram illustrating the details of an embodiment of a DSLAM according to an aspect of present invention.

FIG. 2 is a flow-chart illustrating the details of a method using which distance of echo points may be determined according to an aspect of present invention.

FIG. 3 is a table illustrating the manner in which an echo point may be identified by using bit sequences with good auto-correlation property according to an aspect of present invention.

FIG. 4 is a block diagram illustrating the details of an embodiment of a wire-line medium processor block according to an aspect of present invention.

### DETAILED DESCRIPTION OF THE PREFERRED EMBODIMENTS

1. Overview

An aspect of the present invention enables determination of distance to echo points of on a wire-line medium from a test point. A sequence of test bits is transmitted (from a test point) on a wire-line medium. The wire-line medium may be monitored to determine a time point at which the sequence of test bits is echoed back. The time elapsed between sending the sequence of test bits and receiving the echo is used to perform a single determination of distance to a corresponding echo point.

Thus, the distance (of echo points associated with which the above-noted approach may be used) may be limited only by how reliably the bits in the echoes can be accurately recovered (as being either 1 or 0). As may be readily appreciated, due to the binary nature (either 1 or 0) of the decision to be made in respect of determining each bit of the echo, each bit may be accurately recovered even with a small difference in strength (i.e., voltage level for 1 versus 0). Accordingly, the approach may scale to long distances as well.

According to another aspect of the present invention, the sequence of test bits is chosen to exhibit good auto-correlation property. A bit sequence (sequence of bits) is said to have good auto-correlation property if the sequence of bits exhibits a low correlation with the bit sequence shifted by one or more positions. By choosing such bit sequences, the time of arrival of echos can be reliably and accurately determined as described below with additional examples.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Example Environment

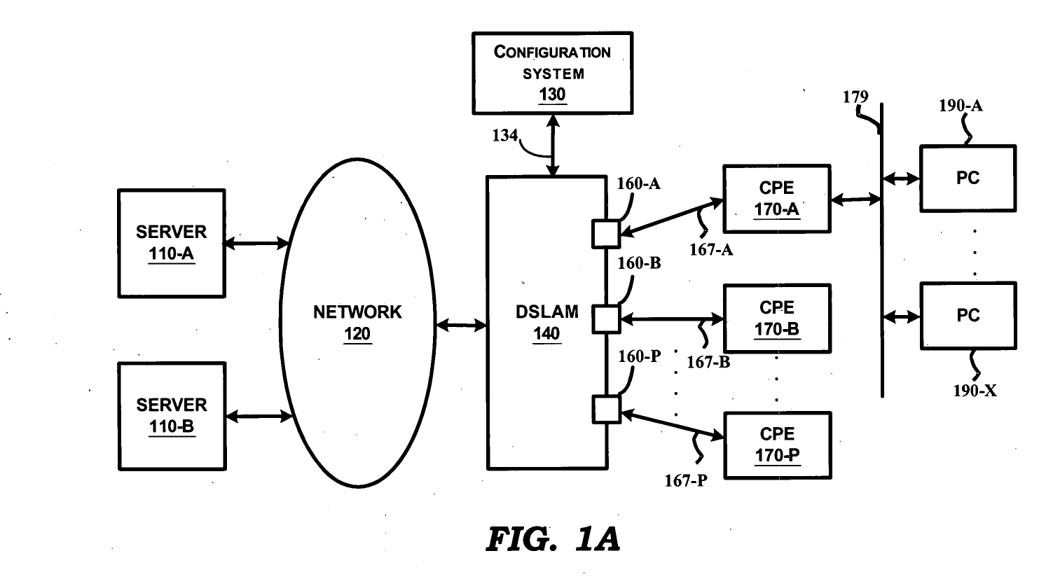

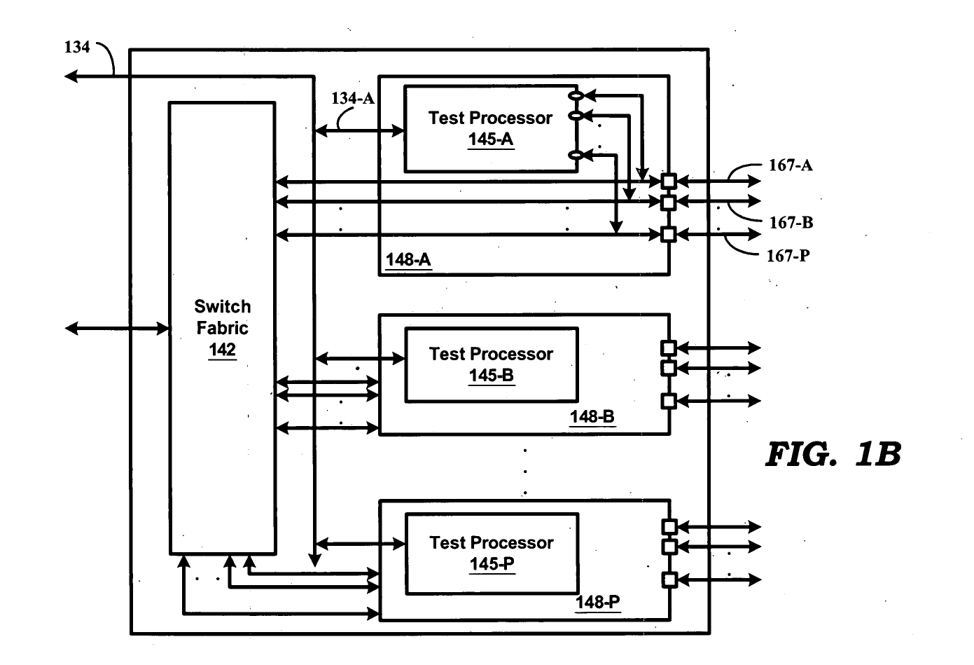

FIG. 1A is a block diagram illustrating the details of an example environment in which the present invention can be implemented. The example environment is shown containing servers 110-A and 110-B, network 120, configuration system 130, DSLAM 140, CPEs (customer premise equipment) 170-A through 170-P, and PCs (personal computers) 190-A through 190-X. Each block is described below in further detail.

The environment is shown containing a few representative components only for illustration. In reality, each environment typically contains many more components. CPE 170-A through 170-P are described with reference to CPE 170-A only for conciseness. Similarly, local loops 167-A through 167-P are described with reference to local loop 167-A.

PCs 190-A through 190-X access server 110-A and/or 110-B using CPE 170-A, DSLAM 140, and network 120. PCs 190-A through 190-X are examples of user systems, and are shown connected to CPE 170-A by local area network (LAN) 179. Network 120 may be implemented using one of ATM, IP and Frame Relay, and may be implemented in a known way.

CPE 170-A receives data packets transmitted by PC 190-A through 190-X, and forwards the contained data to DSLAM 140 on local loop 167-A. Similarly, data received from DSLAM 140 (on local loop 167-A) is forwarded to the appropriate one of the PCs 190-A through 190-X. In one embodiment, the communication between PCs and CPE 190-A is implemented using Internet Protocol (IP).

DSLAM 140 receives data packets from CPEs 170-A through 170-P (respectively on local loops 167-A through 167-P), and transmits the received data packets to network 120. Similarly, DSLAM 140 receives data packets from network 120, and forwards the received data packets respectively via ports 160-A through 160-P to one of CPE 170-A through 170-P (respectively on local loops 167-A through 167-P).

It may be desirable to determine the distance to echo points on any of the local loops, for example, to qualify the local loop prior to providing a service. DSLAM 140 operates in conjunction with configuration system 130 to determine such distances as described below in further detail. The description is continued with respect to an embodiment of DSLAM 140, and then the manner in which the distances can be determined.

3. DSLAM

FIG. 1B is a block diagram illustrating the details of DSLAM 140 in an embodiment of the present invention. The block diagram is shown containing switch fabric 142, and DSLAM cards 148-A through 148-P. DSLAM cards 148-A through 148-P are respectively shown containing test processorblocks 145-A through 145-P. Each block as relevant to various aspects of the present invention is described below.

DSLAM 140 is shown containing a few representative components only for illustration. In reality, DSLAMs typically contains many more components. DSLAM card 148-A through 148-P are described with reference to DSLAM card 148-A only for conciseness. Similarly, local loops 167-A through 167-P are described with reference to local loop 167-A.

Switch fabric 142 receives data packets on one of the paths from DSLAM card 148-A through 148-P destined to servers 110-A/110-B and transfers the data to network 120. Data packets from servers 110-A/110-B (received from network 120) destined to PC 190-A through 190-X are transferred to the corresponding one of DSLAM cards 148-A through 148-P. Switch fabric 142 may be implemented in a known way.

DSLAM card 148-A is shown containing several ports, with each port being connected to a corresponding local loop. Test processor145-A may receive instructions on the specific local loop, on which the distances to echo points are to be determined. The manner in which the distances can be determined is described below in further detail.

4. Method

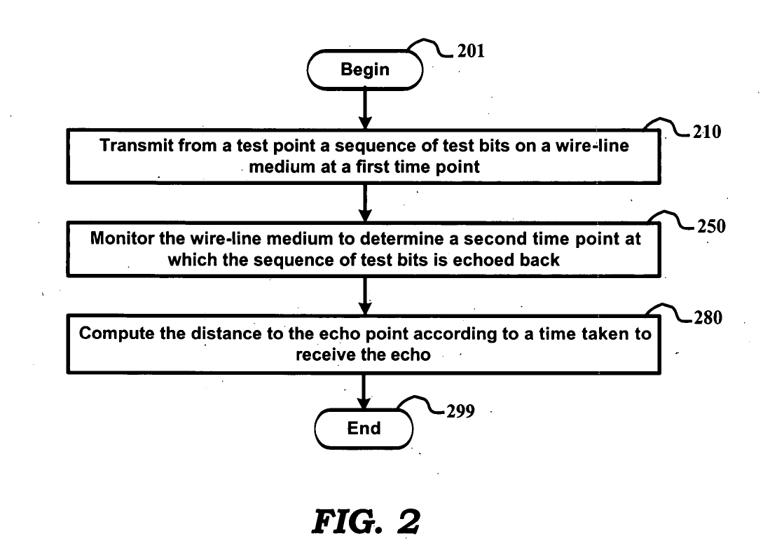

FIG. 2 is a flow-chart illustrating the manner in which distance to an echo point may be determined according to an aspect of present invention. The method is described with reference to FIGS. 1A and 1B merely for illustration. However, the method may be implemented to determine distance to echo points in other environments as well. The method begins in step 201, in which control immediately passes to step 210.

In step 210, a sequence of test bits are transmitted from a first test point on a wire-line medium. With reference to FIG. 1A and 1B, test processor145-A transmits a sequence of test bits on local loop 167-A (via port 160-A) from the connected port (on DSLAM card 148-A). For illustration, the sequence of test bits are assumed to be transmitted starting at time point t₀.

In step 250, wire-line medium is monitored to determine a second time point (e.g., t₁) at which an echo of the sequence of test bits is received. In general, the data bits (“monitored bit sequence”) representing the signal level on the medium are generated, and the generated bits are examined for a match with the sequence of test bits transmitted earlier.

In step 280, the distance to an echo point is computed according to a time taken to receive the echo. For example, the difference of t₁, and t₀ may be multiplied by the velocity of propagation (of signals/bits) on the wire-line medium to determine the distance to a first echo point (from a test point). The method ends in step 299.

Thus, the above-described approach can be used to determine the distance to an echo points. It may be appreciated that the approach can be extended to determining distances to other echo points as well. In general, assuming that the echo points are apart by a resolution supported by the bit sequence and rate (number of bits transmitted per unit time, as described in sections below) of transmission, a corresponding number of echos are received in response to sending a single sequence of test bits.

The distance to each of the echo points may be determined based on the time elapsed between sending the sequence of test bits and receiving the corresponding echo. The description is continued with reference to the manner in which the implementation of various tasks may be split between configuration system 130 and test processor145-A.

5. Configuration System and Wire-Line Medium Test Processor

In one embodiment, configuration system 130 specifies various data elements used while determining echo distances. Examples of such data elements include the rate at which sequence of test bits are to be transmitted, repetition rate to transfer the sequence (assuming multiple determinations of echo distances will be performed), the specific port on which the local loop of interest is connected, and a sequence of test bits that need to be transmitted.

Test processor 145-A may receive all such data elements, and then perform steps 210 (sending the sequence) and 250 (monitoring) described above. The resulting monitored bit sequence may be examined either within test processor145-A or configuration system 130. In case of examination within configuration system 130, test processor145-A sends the monitored bit sequence along with time stamps indicating when the bits are received.

Alternatively, test processor145-A may be designed to forward the monitored bit sequence in real-time speed (i.e., without much latency), and configuration system 130 may determine the time of reception of the specific portions (bits) of monitored bit sequences.

Test processor145-A may send the sequence of test bits multiple times at intervals specified by the repetition rate, and a corresponding number of single determinations of distance to echo points performed. The repetition rate generally has to be small enough (or the interval long enough) such that echos (having meaningful signal strength) resulting from different sequences of test bits do not overlap.

A final determination of the distance to echo points may be performed based on the results of the single determination, for example, by averaging valid results. Thus, the distance to echo points may be determined using the approach(es) described above.

In general, it is desirable that the echoes be identified accurately, i.e., presence be detected when the signal on the wire-line medium represents an echo (or small portion thereof being distorted by noise) and wrong determinations of presence of echo not be made (i.e., avoiding false-positive determinations). Such objectives may be achieved by appropriate bit pattern for the sequence of test bits. An example pattern, which enables such objectives to be met is described below.

6. Auto-Correlation

According to an aspect of the present invention, the sequence of test bits is chosen to exhibit good auto correlation property. As noted above, a bit sequence (sequence of bits) is said to have good auto-correlation property if the sequence of bits exhibits a low correlation with the bit sequence shifted by one or more positions. In an embodiment, relaxed Barker codes are used as the sequence of test bits. In general, the basic Barker codes do not exceed 13-bit length and exhibit excellent auto-correlation properties.

The peak value of auto-correlation of a sequence is directly proportional to the sequence length N in bits. An ideal auto-correlation of a sequence would exhibit only a single peak at a zero shift and a single low value for any bit-shifted version. Such auto-correlation properties are generally approached with very long sequence lengths and basic sequence approaching pseudo random noise like behavior. Auto-correlation of known (practical sequences) exhibit a single high peak at zero shift and a number of side lobe peaks for other specific bit shifts. Longer the length of the sequence, the ratio of main peak to side-lobe peak increases.

Thus, for obtaining a better SNR (signal to noise ratio) of the echo signal for long wire lines, the sequence length N may be increased. Consequently, combinations of Barker codes referred to as Relaxed Barker Codes with longer lengths and good auto-correlation properties are employed. By choosing bit sequences with good auto correlation property, the time of arrival of echos can be reliably and accurately determined as described below with additional examples.

In an embodiment, a portion of the monitored bit sequence (equal in number compared to sequence of test bits) is compared with the sequence of test bits, and correlation factor is set to the number of matching bits. The comparison is repeated potentially with generation of each monitored bit. In such an embodiment, the correlation factor would be substantially high when the monitored bit sequence equals the sequence of test bits (and low in other cases), i.e., when an echo is received, as described below in further detail.

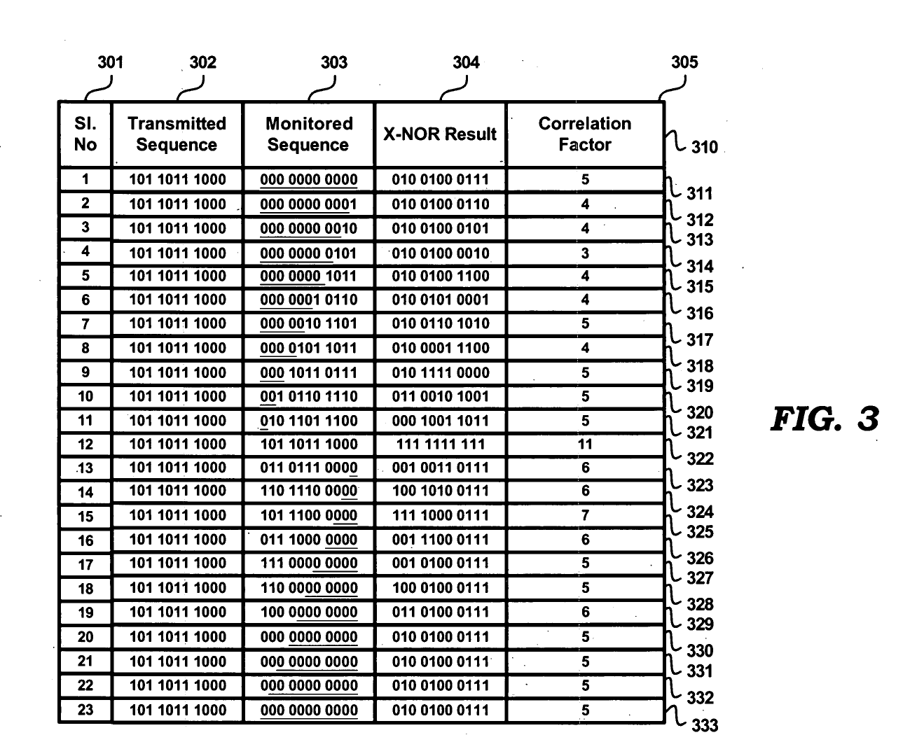

FIG. 3 is a table illustrating the manner in which echo points are reliable identified by using sequence of test bits exhibiting good auto-correlation according to an aspect of present invention. For illustration, the sequence of test bits is assumed to equal a 11-bit Barker Sequence of 101 1011 1000. However, other sequences may be chosen without departing from the scope and spirit of various aspects of the present invention.

The table is shown containing five columns 301 through 305 and twenty three rows 310 through 332. Header row 310 contains the five labels for the five respective columns 301 through 305—sl. no (serial number) 301, transmitted sequence (of test bits) 302, monitored sequence 303, X-NOR result 304, and correlation factor 305.

It is helpful to appreciate that (each entry of) X-NOR result 304 represents the result X-NOR logical operation of transmitted sequence 302 and monitored sequence 303 (of the same row) on a bit-by-bit basis. The number of 1s in X-NOR result 304 equals correlation factor 305 for each row (as briefly described above). The contents of each row is described below in further detail.

Row 311 contains a monitored sequence 303 of all 0s, generally representing no active signal on the wire-line medium. The bits corresponding to such signal (i.e., no active) are shown underlined for reader's convenience. The correlation factor is shown equaling 5. From row 312 onwards up to row 322, each row is shown shifting in an extra bit of (the echo of) the sequence of test bits. Thus, monitored sequence 303 of row 322 is shown containing the entire sequence of test bits echoed back (corresponding to a maximum correlation factor 11). From row 323 through 333, each row is shown shifting out the echoed sequence of test bits bit by bit.

By examining the values in correlation factor 305, it may be appreciated that a high value (of 11) is generated only when the monitored sequence matches (or equals) the transmitted sequence, and a low value (3 to 7) otherwise. The echo may be detected reliably even if one or two bits are received in error because of the difference in value. The approach may be designed to be tolerant to more number of errors (in bit reception) by choosing a longer sequence of test bits. Some general consideration in choosing the length of the sequence of test bits are noted below.

7. Length and Rate of Transmission

As noted above, a longer sequence of test bits may generally result in a corresponding increase in tolerance to the number of errors in bits received and also in accurate determination of presence/absence of echo. However using a too long sequence would need higher transmission rate to distinguish between closely spaced echo points. The two-wire line would show a far greater attenuation at higher transmission frequencies. Thus, a designer may need to choose suitable values of length of the sequence and the rate of transmission to attain a desired resolution. Assuming that the desired resolution is R (units of length) and V is the velocity of propagation of the bits, the time (Ts) taken for a signal to travel R is given by:
Ts=R/V Equation (1)

Assuming the rate of transmission of sequence of test bits is F bits/unit time, and the number of bits in the sequence of test bits equals N, the time to transmit (Tx) the sequence of test bits equals:
Tx=N/F Equation (2)

To avoid overlap of echos of two different echo points at a distance of R, the following Equation needs to be satisfied:
Tx<2 Ts Equation (3)

Substituting Equations 1 and 2 in Equation 3:
N/F<2R/V Equation (4)

Thus, given that V can be determined based on the medium of transmission, a designer may control the frequence of transmission (F) and/or the number of bits in the sequence of test bits to support desired value of R. The description is continued with reference to the details of an example embodiment of the wire-line medium test processor.

8. Wire-Line Medium Test Processor

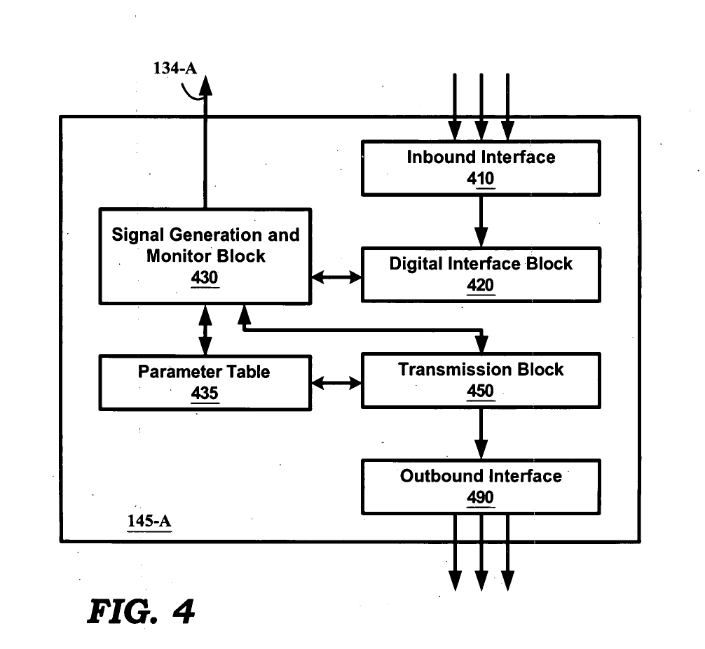

FIG. 4 is a block diagram illustrating the details of a test processor according to an aspect of present invention. Test processor145-A is shown containing inbound interface 410, digital interface block 420, signal generation and monitor block 430, transmission block 450, and outbound interface 490. Each block is described below in further detail.

Inbound interface 410 provides physical, electrical, and protocol interface to generate bits representing the voltage level on the wire-line medium being tested/qualified. Outbound interface 490 provides physical, electrical, and protocol interface to transmit bits on the wire-line medium. Both inbound interface 410 and outbound interface 490 may be implemented in a known way.

Signal generation and monitor block 430 receives data representing various data elements (e.g., sequence of test bits, transmission bit rate, repetition rate, indication of wire-line medium to be tested) sent by configuration system 130 and populates the parameter table 435 accordingly. Signal generation and monitor block 430 may cause transmission block 450 to initiate transmission of the sequence of test bits.

In addition, in one embodiment, signal generation and monitor block 430 detects the reception of the echo and computes distances. In the alternative, signal generation and monitor block 430 merely detects the reception of the echo and passing the relevant data for off-line processing (on path 134-A to configuration system 130). In general, at the point of determination of presence of an echo, a time stamp (or equivalent number) representing the time of arrival of the corresponding monitored sequence, maybe required to compute the time to receive an echo.

In an embodiment employing sequence of test bits exhibiting good auto-correlation property, signal generation and monitor block 430 contains a shift register (not shown) which shifts in a bit in each clock cycle. An XNOR operation is performed on a bit by bit basis with the sequence of test bits, and when all XNOR (or with some margin for error in the wire-line medium) operations generate a 1 indicating a match, an echo is deemed to have been received.

Transmission block 450 transmits the sequence of test bits, potentially as specified by configuration system 130. Data representing the transmission bit rate and specific sequence of test bests may be retrieved from parameters table 435. In addition, the number of times and rate of transmitting the sequence of test bits may also be determined based on values stored in parameters table 435. Digital interface block 420 interfaces with signal generation and monitor block 430 and inbound interface 410 to transmit the test bits and user data (i.e., the data unrelated to testing, but originating from user systems/applications).

Based on the detection of echos, distance to an echo point on a wire-line medium may be determined. As the approaches may depend only on ability to distinguish between 0 and 1 on an echoed signal, the approaches may be potentially be used with testing/qualifying long wire-line mediums.

9. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

1. A method of performing a single determination of distance to an echo point in a wire-line medium, said method comprising:
transmitting a first sequence of bits on said wire-line medium;
monitoring said wire-line medium to determine reception of said first sequence of bits as an echo from said echo point; and
computing a distance to said echo point according to a time taken to receive said echo after said transmitting, whereby said single determination is performed based on said first sequence of bits.

2. The method of claim 1, wherein said first sequence of bits exhibits a good auto-correlation property, whereby said first sequence of bits exhibits a low correlation with said first sequence of bits shifted by one or more positions.

3. The method of claim 2, wherein said monitoring comprises:
generating a monitored sequence of bits by sampling a signal received on said wire-line medium; and
comparing said monitored sequence of bits and said first sequence of bits on a bit by bit basis.

4. The method of claim 3, wherein said generating and said comparing are performed continuously such that said reception of echo can be determined accurately.

5. The method of claim 3, wherein said comparing comprises performing a XNOR operation.

6. The method of claim 3, wherein said generating comprises setting a monitored bit to a logical 0 if a voltage level on said wire-line medium is less than a threshold voltage and to logical 1 otherwise.

7. The method of claim 3, wherein said monitoring further comprises measuring a correlation factor representing a number of matching bits encountered in said comparing.

8. The method of claim 1, said computing comprises multiplying said time taken with a velocity value, wherein said velocity value corresponds to velocity of propagation of bits on the said wire-line medium.

9. The method of claim 1, wherein said wire-line medium comprises a local loop.

10. An line card performing a single determination of distance to an echo point in a wire-line medium, said line card comprising:
a port coupled to said wire-line medium;
means for transmitting a first sequence of bits on said port; and
means for monitoring said wire-line medium to determine reception of said first sequence of bits as an echo from said echo point,
wherein a distance to said echo point is computed according to a time taken to receive said echo after said transmitting, whereby said single determination is performed based on said first sequence of bits.

11. The line card of claim 10, wherein said first sequence of bits exhibits a good auto-correlation property, whereby said first sequence of bits exhibits a low correlation with said first sequence of bits shifted by one or more positions.

12. The line card of claim 11, wherein said means for monitoring is operable to:
generate a monitored sequence of bits by sampling a signal received on said wire-line medium; and
compare said monitored sequence of bits and said first sequence of bits on a bit by bit basis.

13. The line card of claim 12, wherein said wire-line medium comprises a local loop.

14. A DSL Access Multiplexor (DSLAM) comprising:
a switch fabric; and
a plurality of line cards coupled to said switch fabric, a first line card contained in said plurality of line cards being coupled to said wire-line medium, said first line card comprising:
a port being coupled to said wire-line medium;
a test processor operable to transmit a first sequence of bits on said wire-line medium, said test processor monitoring said wire-line medium to determine reception of said first sequence of bits as an echo from said echo point,
wherein a distance to said echo point can be computed according to a time taken to receive said echo after said transmitting, whereby said single determination is performed based on said first sequence of bits.

15. The DSLAM of claim 14, wherein said first sequence of bits exhibits a good auto-correlation property, whereby said first sequence of bits exhibits a low correlation with said first sequence of bits shifted by one or more positions.

16. The DSLAM of claim 15, wherein said test processor is further operable to generate a monitored sequence of bits by sampling a signal received on said wire-line medium, and comparing said monitored sequence of bits and said first sequence of bits on a bit by bit basis.

17. A test processor for performing a single determination of distance to an echo point in a wire-line medium, said test processor comprising:
an outbound interface;
a transmission block causing said outbound interface to transmit a first sequence of bits on said wire-line medium; and
an inbound interface generating a monitored sequence based on a signal received on said wire-line medium,
wherein said monitored sequence is examined to determine reception of said first sequence of bits as an echo from said echo point, and wherein a distance to said echo point is computed according to a time taken to receive said echo after said transmitting, whereby said single determination is performed based on said first sequence of bits.

18. The test processor of claim 17, further comprising a signal generation and monitor block which receives data indicating a specific port on which said wire-line medium is connected, wherein said first sequence of bits are caused to be transmitted on said specific port.

19. The test processor of claim 18, wherein said signal generation and monitor block examines said monitored sequence to determine reception of said first sequence of bits.

20. The test processor of claim 19, wherein said signal generation and monitor block receives said first sequence of bits and a data bit rate from an external system, wherein said first sequence of bits are transmitted at said bit rate.

21. The test processor of claim 19, further comprising a parameters table storing said first sequence of bits and said bit rate.

22. The test processor of claim 18, wherein said signal generation and monitor block examines said monitored sequence to determine reception of said first sequence of bits as an echo from said echo point, and computing a distance to said echo point according to a time taken to receive said echo after said transmitting, whereby said single determination is performed based on said first sequence of bits.

23. The test processor of claim 18, wherein said first sequence of bits exhibits a good auto-correlation property, whereby said first sequence of bits exhibits a low correlation with said first sequence of bits shifted by one or more positions.

24. The test processor of claim 23, wherein said first sequence of bits comprise relaxed Barker codes.
